(19) United States
(12) Patent Application Publication
(10) Pub. No.: US 2010/0214227 A1
(43) Pub. Date: Aug. 26, 2010

(54) DUAL SCREEN PORTABLE ELECTRONIC DEVICE

(75) Inventors: KUAN-HONG HSIEH, Tu-Cheng (TW); TEH-SHEN LEE, Tu-Cheng (TW); CHIUNG-LI CHANG, Tu-Cheng (TW); XIAO-GUANG LI, Shenzhen City (CN); YU-HAO CHYAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/504,671

(22) Filed: Jul. 17, 2009

(30) Foreign Application Priority Data
Feb. 26, 2009 (CN) 200910300570.1

(51) Int. Cl. G06F 3/02; G09G 5/00; G06F 3/01

(52) U.S. Cl. 345/169; 345/1.3; 345/156

(57) ABSTRACT

A dual screen portable electronic device is provided. The portable electronic device includes a first group of function interfaces, a second group of function interfaces, a first screen, a second screen and a central processing unit. The first screen is configured for displaying the first group of function interfaces. The second screen is configured for displaying the second group of function interfaces. The central processing unit is configured for controlling one of the first screen or the second screen to be in an activated state and the other to be in an inactivated state, performing functions corresponding to the function interfaces, and controlling the activated screen to display the function interfaces.

### BACKGROUND

1. Technical Field

The disclosure relates to a portable electronic device and, more particularly, to a dual screen portable electronic device.

2. Description of the Related Art

Nowadays, many types of electronic devices, such as some types of conventional mobile phones, have only one screen. Moreover, a mobile phone commonly includes a keypad which usually occupies nearly half of the area of a functional panel on the mobile phone, and displays a small user interface for a user. Therefore, it is uncomfortable for the user to read contents on the screen of the conventional mobile phone. Furthermore, conventional mobile phones usually adopt thin film transistor (TFT) screens which consume energy even in a standby state.

### BRIEF DESCRIPTION OF THE DRAWINGS

The components in the drawings are not necessarily drawn to scale, the emphasis instead being placed upon clearly illustrating the principles of the dual screen portable electronic device. Moreover, in the drawings, like reference numerals designate corresponding parts throughout the several views.

FIG. 1 is a schematic front view of a dual screen portable electronic device in accordance with an embodiment.

FIG. 2 is a schematic rear view of the dual screen portable electronic device of FIG. 1 in accordance with an embodiment.

FIG. 3 is a schematic rear view of the dual screen portable electronic device of FIG. 1 in accordance with an alternative embodiment.

FIG. 4 is a block diagram of the dual screen portable electronic device of FIG. 1 in accordance with an embodiment.

FIG. 5 is a block diagram of the dual screen portable electronic device of FIG. 1 in accordance with an alternative embodiment.

### DETAILED DESCRIPTION

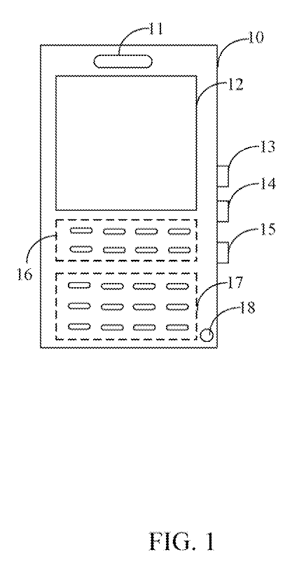

FIG. 1 is a schematic front view of a dual screen portable electronic device in accordance with an embodiment. The dual screen portable electronic device (hereinafter “the portable electronic device”) is a mobile phone, or a personal digital assistant (PDA), or the like. The portable electronic device includes a front surface 10. The front surface 10 includes a receiver 11, an electronic ink (E-ink) screen 12, a plurality of function keys 16, a plurality of alphanumeric keys 17 and a microphone 18. The portable electronic device further includes a screen-switch key 13, a function-switch key 14 and an interface-share key 15, which are located on one side of the portable electronic device in the embodiment.

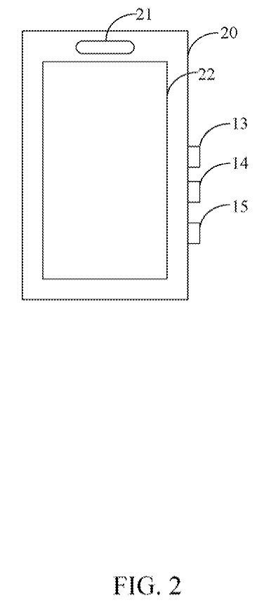

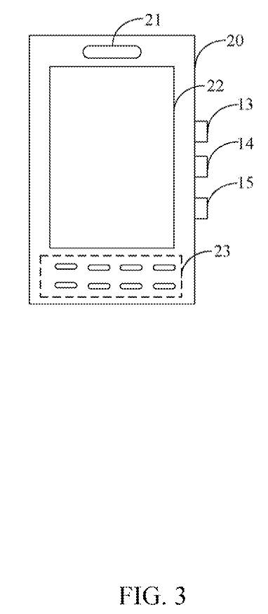

As shown in FIG. 2, the portable electronic device further includes a rear surface 20. The rear surface 20 includes a speaker 21 and a TFT touch screen 22. The TFT touch screen 22 occupies nearly the whole rear surface 20. In an alternative embodiment, as shown in FIG. 3, the rear surface 20 is further located with a plurality of function keys 23.

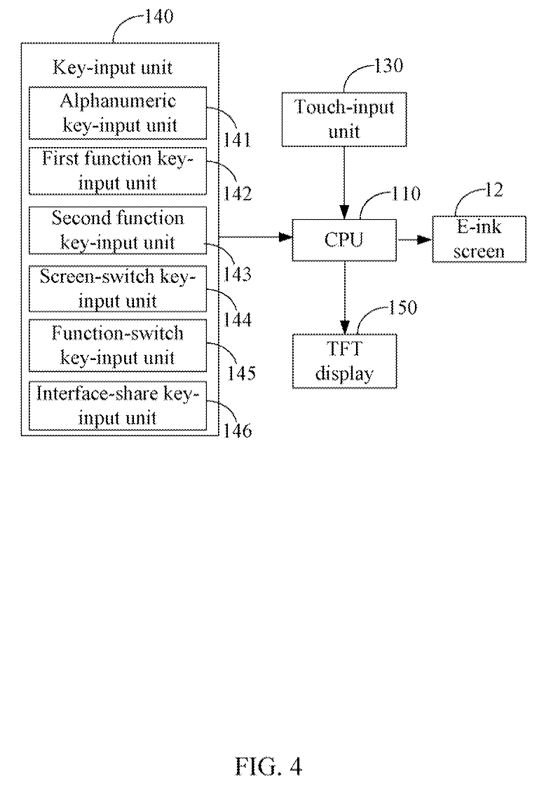

FIG. 4 is a block diagram of the dual screen portable electronic device of FIG. 1 in accordance with an exemplary embodiment. The TFT touch screen 22 is implemented by a TFT display 150 and a touch-input unit 130 covering the TFT display 150. The touch-input unit 130 is configured for receiving and recognizing touch operations exerted by the user on the TFT touch screen 22. The touch-input unit 130 is also configured for transmitting signals corresponding to the touch operations to a central processing unit (CPU) 110, so that the CPU 110 performs functions corresponding to the touch operations. The portable electronic device further includes a key-input unit 140. The key-input unit 140 is configured for receiving and recognizing press operations exerted by the user on the various keys distributed on the portable electronic device.

The key-input unit 140 includes an alphanumeric key-input unit 141, a first function key-input unit 142, a second function key-input unit 143, a screen-switch key-input unit 144, a function-switch key-input unit 145 and an interface-share key-input unit 146. Corresponding to the exemplary embodiment shown with FIGS. 1 and 3, the alphanumeric key-input unit 141, the first function key-input unit 142, the second function key-input unit 143, the screen-switch key-input unit 144, the function-switch key-input unit 145 and the interface-share key-input unit 146 receive and recognize press operations exerted by the user on the alphanumeric keys 17, the first function keys 16, the second function keys 23, the screen-switch key 13, the function-switch key 14, and the interface-share key 15. The key-input unit 140 is further configured for transmitting signals corresponding to the press operations to the CPU 110, so that the CPU 110 performs functions corresponding to the press operations.

The portable electronic device has a plurality of function interfaces which have been divided into two groups in the exemplary embodiments. Each of the groups includes function interfaces, and is assigned to one or both of the E-ink screen 12 and the TFT touch screen 22 to display. For example, the E-ink screen 12 displays a first group of the function interfaces which may include a phonebook interface, short message interfaces, and an audio player interface, and the TFT display 150 displays a second group of the function interfaces which may include game interfaces and a video player interface.

When the E-ink screen 12 is in an activated state, the CPU 110 controls the E-ink screen 12 to display the first group of the function interfaces and performs corresponding functions in response to the press operations exerted on the alphanumeric keys 17 and the first function keys 16. When the TFT display 150 is in an activated state, the CPU 110 controls the TFT display 150 to display the second group of the function interfaces and performs corresponding functions in response to the touch operations exerted on the touch-input unit 130 or the press operations exerted on the second function keys 23. In an alternative embodiment, one or more function interfaces such as the audio player and an incoming call interfaces and some basic information such as signal strength, battery remaining capacity, and current date and time are included in both groups and assigned to both the E-ink screen 12 and the TFT display 150 to display.

The CPU 110 is also configured for alternatively controlling one of the E-ink screen 12 or the TFT display 150 to be in an activated state, and the other to be in an inactivated state. For example, when the portable electronic device is turned on, the CPU 110 controls the E-ink screen 12 to enter the activated state and the TFT display 150 is left in the inactivated state.

The CPU 110 is further configured for switching the E-ink screen 12 and the TFT touch screen 22 between the activated state and the inactivated state in response to a screen-switch signal from the screen-switch key-input unit 144. For example, when the E-ink screen 12 is in the activated state and the TFT display 150 is in the inactivated state, the CPU 110 switches the E-ink screen 12 to the inactivated state, and the TFT display 150 to the activated state in response to the screen-switch signal from the screen-switch key-input unit 144, and further controls the TFT display 150 to display the second group of the function interfaces in response to signals from the touch-input unit 130 and the second function key-input unit 143.

When the portable electronic device senses that the ambient is a dark place, the E-ink screen 12 does not display any interface. The TFT display 150 is configured for displaying both the first and the second groups of function interfaces. The CPU 110 is further configured for switching the TFT display 150 to display both the first and the second groups of function interfaces in response to a function-switch signal from the function-switch key-input unit 145 in the dark place. When the TFT display 150 is in the activated state, the CPU 110 controls the TFT display 150 to display both the first and the second groups of function interfaces in response to the function-switch signal from the function-switch key-input unit 145. The CPU 110 is further configured for switching the TFT display 150 back to display the second group of function interfaces only in response to a next function-switch signal from the function-switch key-input unit 145.

The CPU 110 is further configured for activating one of the E-ink screen 12 and the TFT touch screen 22 to display an interface (or an image) when the other is displaying the interface (or the image) in response to an interface-share signal from the interface-share key-input unit 146. For example, when the E-ink screen 12 displays a photo, the CPU 110 activates the TFT display 150 and controls the TFT display 150 to display the photo in response to the interface-share signal from the interface-share key-input unit 146, and the CPU 110 does not respond to the signals from the touch-input unit 130 and the second function key-input unit 143 which are intended to operates (or processes) the displayed interface (or image). The CPU 110 is further configured for terminating the interface share in response to a next interface-share signal from the interface-share key-input unit 146.

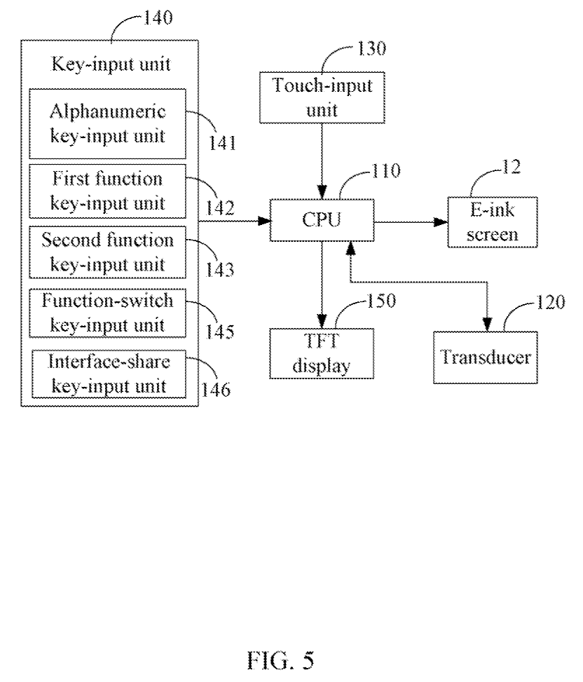

FIG. 5 is a block diagram of the dual screen portable electronic device of FIG. 1 in accordance with an alternative embodiment. Compared to the embodiment in FIG. 4, the portable electronic device further includes a transducer 120 replacing the screen-switch key 13 and the screen-switch key-input unit 144. The transducer 120 is configured for sensing a quick shake of the portable electronic device and transmitting a quick-shake signal to the CPU 110 in response to the quick shake of the portable electronic device. Upon receiving the quick-shake signal from the transducer 120, the CPU 110 switches the inactivated screen to the activated state and the activated screen to the inactivated state.

It is understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A dual screen portable electronic device, comprising:
a first group of function interfaces;
a second group of function interfaces;
a first screen, for displaying the first group of function interfaces;
a second screen, for displaying the second group of function interfaces; and
a central processing unit, for controlling one of the first screen or the second screen to be in an activated state and the other to be in an inactivated state, performing functions corresponding to the function interfaces, and controlling the activated screen to display the function interfaces.

2. The portable electronic device as recited in claim 1, wherein the first screen is an E-ink screen and the second screen is a thin film transistor (TFT) touch screen comprising a TFT display and a touch-input unit covering the TFT display.

3. The portable electronic device as recited in claim 2, wherein the portable electronic device has a front surface comprising the E-ink screen.

4. The portable electronic device as recited in claim 3, wherein the front surface further comprises a receiver, a plurality of function keys, a plurality of alphanumeric keys and a microphone.

5. The portable electronic device as recited in claim 2, wherein the portable electronic device has a rear surface comprising the TFT touch screen.

6. The portable electronic device as recited in claim 5, wherein the rear surface further comprises a speaker.

7. The portable electronic device as recited in claim 1, further comprising a side, a screen-switch key located on the side and a screen-switch key-input unit located inside the portable electronic device, wherein the screen-switch key-input unit is configured for receiving and recognizing press operations exerted on the screen-switch key and transmitting screen-switch signals corresponding to the press operations to the central processing unit, and the central processing unit is further configured for switching the first screen and the second screen between an activated state and an inactivated state according to the screen-switch signals.

8. The portable electronic device as recited in claim 1, further comprising a side, a function-switch key located on the side and a function-switch key-input unit located inside the portable electronic device, wherein the second screen is also configured for displaying both the first and the second groups of function interfaces, the function-switch key-input unit is configured for receiving and recognizing a press operation on the function-switch key and transmitting a function-switch signal corresponding to the press operation to the central processing unit, and the central processing unit is further configured for switching the second screen between displaying only the second group of function interfaces and displaying both the first and the second groups of function interfaces in response to the function-switch signal.

9. The portable electronic device as recited in claim 1, further comprising a side, an interface-share key located on the side, and an interface-share key-input unit located inside the portable electronic device, wherein the interface-share key-input unit is configured for receiving and recognizing a press operation on the interface-share key and transmitting an interface-share signal corresponding to the press operation to the central processing unit, and the central processing unit is further configured for activating the inactivated screen to synchronously display contents along with the activated screen in response to the interface-share signal.

10. The portable electronic device as recited in claim 9, wherein the central processing unit is further configured for terminating the synchronous display of contents on both the first screen and the second screen in response to a next interface-share signal from the interface-share key-input unit.

11. The portable electronic device as recited in claim 2, wherein the central processing unit is further configured for controlling the E-ink screen to enter the activated state and the TFT touch screen is left in an inactivated state when the portable electronic device is turned on.

12. The portable electronic device as recited in claim 2, further comprising a transducer, wherein the transducer is configured for sensing a quick shake of the portable electronic device and transmitting a quick-shake signal to the central processing unit in response to the quick shake of the portable electronic device and the central processing unit is further configured for switching the inactivated screen to the activated state and the activated screen to the inactivated state in response to the quick-shake signal.

13. The portable electronic device as recited in claim 1, wherein the first group of function interfaces include a phonebook interface, short message interfaces and an audio player interface, and the second group of function interfaces include game interfaces and a video player interface.

14. The portable electronic device as recited in claim 1, wherein both the first and the second groups of function interfaces comprise at least one same function interface.

15. The portable electronic device as recited in claim 14, wherein the at least one same function interface comprise an incoming call interface and an audio player interface.

16. The portable electronic device as recited in claim 1, wherein both the first and the second groups of function interfaces comprise the same basic information.

17. The portable electronic device as recited in claim 16, the same basic information comprises signal strength, battery remaining capacity, current date and time.
